(19) United States
(12) Patent Application Publication
(10) Pub. No.: US 2003/0048381 A1
(43) Pub. Date: Mar. 13, 2003

(54) Television system and method of use thereof

(75) Inventor: Terry L. Glatt, Pompano Beach, FL (US)

Correspondence Address: HEAD, JOHNSON & KACHIGIAN, 228 W 17TH PLACE, TULSA, OK, 74119, US

(73) Assignee: PACE MICRO TECHNOLOGY PLC.

(21) Appl. No.: 10/236,367

(22) Filed: Sep. 6, 2002

(30) Foreign Application Priority Data
Sep. 7, 2001 (GB) 0121776.9

(51) Int. Cl. H04N 7/16; H04N 5/445

(52) U.S. Cl. 348/563; 348/564; 725/151; 725/139

(57) ABSTRACT

A television system is provided which includes a broadcast data receiver (BDR). The BDR receives digital data from a broadcaster at a remote location. The digital data includes video, audio and/or auxiliary data relating to a number of channels and/or television programmes for showing on a television display screen. The BDR is connected to an Internet provider for the receipt and/or delivery of electronic documents, such as e-mails. The system further includes a remote control handset to allow a user to select one or more functions or operations of the television system. The BDR is further provided with a plurality of pre-defined messages stored in memory thereof. When an e-mail is received by the BDR and the document receipt is notified to a user of the system, said user can choose to reply to the e-mail by selecting a pre-defined message using the remote control.

This invention relates to a television system and method of use thereof, and particularly to a television system including a broadcast data receiver having an Internet connection to allow receipt and/or transmission of electronic documents therefrom.

The television system as described herein typically includes a display screen connected to or integrally formed with a broadcast data receiver (BDR). The BDR receives digital data from a broadcaster at a remote location and decodes and processes the data to provide video, audio and/or auxiliary data for display on the display screen or listening via speakers connected to the system. The data typically relates to a number of television programmes and/or channels. In addition, the user's BDR is provided with a further communications link, such as an Internet connection, to allow a user of the system to receive and/or send electronic documents, such as e-mails, from an e-mail address. The system is further provided with control means, typically in the form of a remote control handset, to allow a user to select one or more functions or operations of the television system, and a QWERTY keyboard to allow e-mail messages to be composed and sent using the system. Conventional BDRs are also typically provided with means by which a user watching the television display screen can be informed that one or more new e-mail messages have been received.

Electronic documents, such as e-mails, often require an immediate response to be sent thereto. However, if a user is watching a television programme of interest to them, and during this programme an e-mail is delivered to them which requires an immediate response, the user may not wish to take a break in their programme viewing for any significant length of time in order to reply to the e-mail. In addition, the QWERTY keyboard provided for use with the television system may not be easy to use for the typing of lengthy e-mails and/or there may not be any suitable surface on which to balance the keyboard in order to type an e-mail response. It is also likely to be inconvenient and frustrating for the user to either move to a computer or miss a part of all of a programme they were watching in order to send an e-mail response.

It is therefore an aim of the present invention to provide a television system and method of use thereof which overcomes the abovementioned problems.

According to a first aspect of the present invention there is provided a television system including a broadcast data receiver (BDR), said BDR for receiving digital data from a broadcaster at a remote location, said digital data including video, audio and/or auxiliary data relating to a number of channels and/or television programmes, said BDR having a suitable communications link for the receipt and/or delivery of electronic documents, said system further including control means to allow a user to select one or more functions/operations of said television system, and wherein said BDR is provided with at least one pre-defined message stored in memory thereof, such that said user can choose, by the selection of said at least one pre-defined message using said control means, to transmit an electronic document independently or in reply to a received electronic document.

Preferably the user's response is sent as a reply to the sender of the received electronic document.

Preferably the suitable communications link in one embodiment is connection with an Internet provider.

In one embodiment a plurality of pre-defined response messages are provided either by a manufacturer and/or broadcaster. Alternatively to, and/or in addition, the messages can be created by the user who inputs a number of pre-defined messages at a convenient point in time for storage in said BDR. The one or more messages can then be retrieved at a later date for reply to a received electronic document, such as an e-mail.

The pre-defined messages are typically stored in memory of the BDR.

The pre-defined message can include, for example, “I'll get back to you”, “Thank-you”, “I'll provide a full response to you later” and/or the like.

Preferably the electronic document being received is in the form of an e-mail, which can include text, video, images audio and/or the like.

Preferably visual and/or audio indication means can be provided. For example, visual indication means in the form of a message and/or icon can be displayed on the display screen and/or an audio signal is sounded via speakers to inform the user that a new e-mail message has been received.

In one embodiment the control means is a handheld remote control unit. One or more buttons on the remote control handset can be used to open the electronic document and to allow a user to read the document if it is in the form of text, such as an e-mail. The same or further buttons can then be used to select a drop down menu on the display screen from which an appropriate e-mail response message can be selected therefrom.

In one embodiment, rather than the user having to select a message from a drop down menu, a pre-defined message is associated with a particular button on the remote control, such that on depression of the appropriate button, the message associated with that particular button is sent in response to the received electronic document.

Preferably a plurality of pre-defined messages can be selected, if required, to form a response to an electronic document. The user has the option to read and/or edit the resulting response once formulated before the response is sent. Alternatively, as soon as a pre-defined message is selected, a response containing that message is sent as the reply.

According to a second aspect of the present invention there is provided a broadcast data receiver (BDR), said BDR receiving digital data from a broadcaster at a remote location, said digital data including video, audio and/or auxiliary data relating to a number of channels and/or television programmes, said BDR having a suitable communications link for the receipt and/or delivery of electronic documents, said BDR having control means to allow a user to select one or more functions/operations of said BDR, and wherein said BDR is provided with a number of pre-defined messages stored in memory thereof, such that when an electronic document is received by said BDR and said document receipt is notified to a user of said system, said user can choose to respond to the receipt of said electronic document by the selection of one or more of said pre-defined messages using said control means.

According to a further aspect of the present invention there is provided a method of replying to electronic documents received by a broadcast data receiver, said BDR receiving and processing digital data from a broadcaster at a remote location, said BDR having a suitable communications link for the receipt and/or delivery of electronic documents and having control means to allow a user to select one or more functions/operations of said BDR, and wherein said method includes the steps of said BDR indicating to a user that one or more new electronic documents have been received, the user selecting to view said one or more electronic documents using said control means, said user then selecting one or more pre-defined response messages stored in memory of said BDR and sending said selected response message or messages using said control means as a reply to the sender of said electronic documents.

It will be appreciated that a pre-defined e-mail message or messages can be sent to one or more e-mail addresses irrespective of whether an e-mail or other electronic document has been received from said addresses. Thus, if a user wants to send a quick pre-defined message to one or more e-mail addresses, such as “GET IN TOUCH SOON”, the user can do so both quickly and easily.

In one embodiment it is possible for the user to select a predefined message for sending via e-mail to their own e-mail address, electronic diary and/or an alternative e-mail address of the user, thereby allowing the original e-mail to be forwarded thereto for later response by the user. In this manner, the user can send themselves reminders and/or the like to their own e-mail account using the television system.

An advantage of the present invention is that the pre-defined email responses can be made quickly and easily using the remote control handset and without the requirement of typing a message using a QWERTY keyboard or other data input device. Thus the user reduces the disruption caused by receiving and sending e-mail messages to and/or from a television.

An embodiment of the present invention will now be described with reference to the accompanying figures wherein:

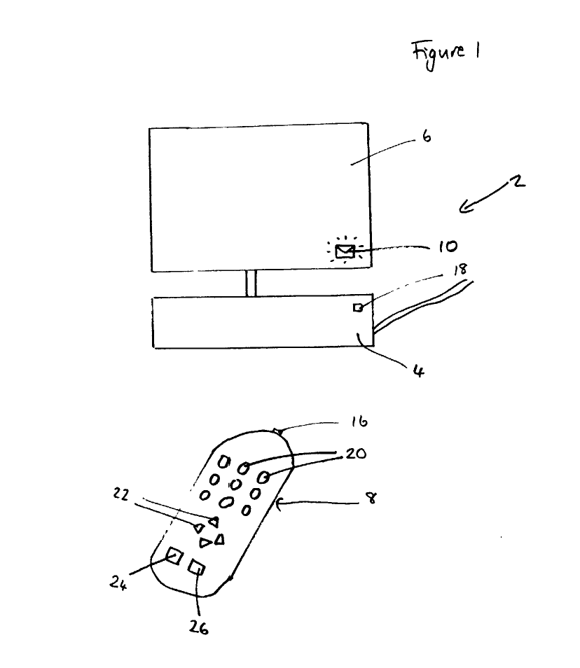

FIG. 1 is a schematic view of a BDR with remote control handset; and

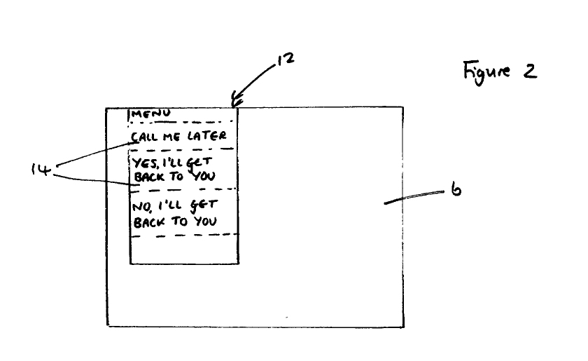

FIG. 2 is an example of a menu for a display screen according to the present invention.

Referring to the figures, there is illustrated a television system 2 including a broadcast data receiver (BDR) 4, a television display screen 6 and a remote control hand set 8.

The BDR 4 receives digital data from a broadcaster at a remote location relating to a plurality of channels and/or television programmes. In addition, the BDR is connected to an Internet provider to allow the receipt and delivery of electronic documents in the form of e-mails to and/or from the BDR.

On receipt of an e-mail by the BDR, the BDR generates indication means in the form of a mail icon 10 which flashes on the TV screen 6 to inform a user that a new mail message has been received. Display of the mail icon 10 is typically a user-selectable option which the user can switch on and/or off as required. In this described embodiment the option is switched on and the mail icon is superimposed over an existing television programme being watched by the user at the time when a new mail message is received. The mail icon typically remains displayed on the screen for a pre-determined time period or until the new mail message is read.

It is often the case that when a new mail message is received at the BDR, the user is engrossed in watching a television programme being shown at that time. The user may quickly read the e-mail message but not want to miss a part or all of the television programme in order to reply to the e-mail.

In accordance with the present invention, the BDR is provided with a selectable drop down menu 12 containing a number of pre-defined messages 14 for providing a quick response to a received e-mail.

The remote control handset 8 is provided with an infra red transmitter/receiver 16 for communicating with an infra red transmitter/receiver 18 on the BDR 4. The handset 8 is provided with a plurality of buttons 20 for selection of one or more functions/operations of the BDR and arrow keys 22 for movement of a cursor or highlighted area on the display screen.

In the described embodiment an e-mail read/open key 24 is provided which when selected by the user allows a new e-mail message, as indicated by the mail icon 10, to be superimposed on the screen and read by the user. A further e-mail reply menu key 26 is provided.

If the user chooses to read the e-mail, the user can then decide whether to ignore the e-mail message or reply to it. If the user chooses to reply to the e-mail, they can use the QWERTY keyboard provided with the BDR to compose a response message or alternatively, in accordance with the present invention, they can choose to send a quick acknowledgement using one of a number of pre-defined response messages. For example, the user may choose to send a quick predefined response is if they consider that writing a full e-mail response would take too long.

Selection of key 26 provides the drop down menu 12, as shown in FIG. 2. The user, having read the e-mail from “the sender” can then select an appropriate response message 14 using the arrow keys 22 to toggle up and down the menu 12. Once the message has been selected, the reply e-mail is automatically sent to the e-mail address of “the sender”, and/or any pre-defined other e-mail address(es), with or without a copy of the original received e-mail.

The pre-defined messages can include, for example, replies such as “call me later”, “yes, I'll get back to you”, “no, I'll get back to you” and/or the like. These replies allow a user to quickly acknowledge receipt of the message from “the sender” without the user having to miss too much of the television programme they are watching.

The drop down pre-defined message list and e-mail display can be superimposed over the television programmes being shown on the display screen, such that a user is able to keep track of the video and/or audio content of the programme whilst replying to the e-mail. Alternatively the drop down menu and email display are provided in windows which overlay or replace the current television display.

A single button press on the remote control can also be used to send a canned response to an e-mail. The canned response is pre-assigned to a particular button by the user or manufacturer.

The pre-defined response messages can be provided by the manufacturer of the BDR and/or the broadcaster. Alternatively, the user can input suitable response messages for storage in memory in the BDR for subsequent display.

Thus the present invention provides a quick and easy method of acknowledging receipt of an electronic document, such as an e-mail, whilst minimising interruption to the user's television viewing. In addition, the present invention provides a means of sending a reminder or message to the user to remind them that a proper full response is required to the quick acknowledged e-mail

1. A television system including a broadcast data receiver (BDR), said BDR for receiving digital data from a broadcaster at a remote location, said digital data including video, audio and/or auxiliary data relating to a number of channels and/or television programmes, said BDR having a suitable communications link for the receipt and/or delivery of electronic documents, said system further including control means to allow a user to select one or more functions/operations of said television system, and wherein said BDR is provided with at least one pre-defined message stored in memory thereof, such that said user can choose, by the selection of said at least one pre-defined message using said control means, to transmit an electronic document independently or in reply to a received electronic document.

2. A television system according to claim 1 wherein the suitable communications link is connection with an Internet provider.

3. A television system according to claim 1 wherein the at least one pre-defined message is provided by any or any combination of a manufacturer of the system, a broadcaster and/or a user of the system.

4. A television system according to claim 1 wherein the at least one pre-defined message is stored in memory of the BDR.

5. A television system according to claim 1 wherein visual and/or audio indication means are provided to inform the user that a new electronic document has been received.

6. A television system according to claim 5 wherein the visual indication means is in the form of a message or icon for display on the display screen.

7. A television system according to claim 1 wherein the control means is a remote controlled handset.

8. A television system according to claim 7 wherein a button on the remote controlled handset is used to open the electronic document.

9. A television system according to claim 8 wherein the button or further button on the remote controlled handset can be used to select a drop down menu on the display screen from which an appropriate e-mail response can be selected therefrom.

10. A television system according to claim 8 wherein the button or further button on the remote controlled handset has a pre-defined message associated therewith, such that on depression of the button or further button, the pre-defined message associated therewith is sent in response to the electronic document.

11. A television system according to claim 1 wherein a plurality of pre-defined messages can be selected to form a response to be sent in reply to an electronic document.

12. A television system according to claim 1 wherein the user has the option to read and/or edit the response once formulated prior to the response being sent.

13. A television system according to claim 1 wherein as soon as a pre-defined message is selected by a user, a response containing the message is sent as the reply.

14. A television system according to claim 1 wherein the electronic document is in the form of an e-mail.

15. A television system according to claim 1 wherein the user can select to send a pre-defined message to their own e-mail address, electronic diary and/or alternative e-mail address of the user.

16. A television system according to claim 1 wherein the pre-defined message can be sent as an e-mail in response to a received electronic document and/or to one or more other e-mail addresses irrespective of whether an electronic document has previously been received from the one or more e-mail addresses.

17. A broadcast data receiver (BDR), said BDR receiving digital data from a broadcaster at a remote location, said digital data including video, audio and/or auxiliary data relating to a number of channels and/or television programmes, said BDR having a suitable communications link for the receipt and/or delivery of electronic documents, said BDR having control means to allow a user to select one or more functions/operations of said BDR, and wherein said BDR is provided with a number of pre-defined messages stored in memory thereof, such that said user can choose, by the selection of said at least one pre-defined message using said control means, to transmit an electronic document independently or in reply to a received electronic document.

18. A method of replying to electronic documents received by a broadcast data receiver, said BDR receiving and processing digital data from a broadcaster at a remote location, said BDR having a suitable communications link for the receipt and/or delivery of electronic documents and having control means to allow a user to select one or more functions/operations of said BDR, and wherein said method includes the steps of said BDR indicating to a user that one or more new electronic documents have been received, the user selecting to view said one or more electronic documents using said control means, said user then selecting one or more pre-defined response messages stored in memory of said BDR and sending said selected response message or messages using said control means as a reply to the receipt of said electronic documents.
